(19) United States
(12) Patent Application Publication
(10) Pub. No.: US 2024/0229959 A1
(43) Pub. Date: Jul. 11, 2024

(54) FLOW PATH SWITCHING VALVE

(71) Applicant: FUJIKOKI CORPORATION, Setagaya-ku, Tokyo (JP)

(72) Inventor: Daisuke KONDO, Setagaya-ku, Tokyo (JP)

(21) Appl. No.: 18/565,391

(22) PCT Filed: Oct. 28, 2022
(86) PCT No.: PCT/JP2022/040540

§ 371 Date: Nov. 29, 2023

(30) Foreign Application Priority Data
Jan. 20, 2022 (JP) 2022-007451

(51) Int. Cl. F16K 31/00; F16K 11/087

(52) U.S. Cl. CPC F16K 31/002; F16K 11/087

(57) ABSTRACT

A flow path switching valve includes: a valve main body having an inlet/outlet port being opened in a pair of a left first wall surface and a right first wall surface facing each other of a valve chamber formed inside; a valve body having a ball shape that is disposed in the valve chamber; an annular seat member disposed between the valve body and the inlet/outlet port and disposed between the left first wall surface and the right first wall surface of the valve chamber facing an outer peripheral portion; an O-ring that presses the seat member against the valve body; a rotary drive unit that rotates the valve body; and an inclined seal surface that is formed on the seat member, that is inclined at a constant angle θ with respect to an axis, and that is in contact with an outer peripheral surface of the valve body.

### TECHNICAL FIELD

The present disclosure relates to a flow path switching valve, and relates to a flow path switching valve that switches a flow path by rotating and sliding a ball-shaped valve body in a valve chamber.

### BACKGROUND ART

Japanese Patent Application Laid-Open (JP-A) 2018-115691 discloses a flow path switching valve of a type in which a flow path is switched by a rotating operation of a ball-shaped valve body.

In this type of flow path switching valve, the valve body is rotationally driven using a rotary drive unit including a motor, a drive gear, and the like.

### SUMMARY OF INVENTION

### Technical Problem

In the flow path switching valve, a pair of annularly formed seat members corresponding to a pair of outflow ports facing each other is disposed in the valve chamber, and the ball-shaped valve body is rotatably and slidably disposed between the pair of seat members. Furthermore, an O-ring as a seal member made of an elastic material such as rubber is disposed in a compressed state between each seat member and the valve main body. Each seat member is pressed by the elastic force (repulsive force) of the O-ring so as to be in close contact with an outer peripheral surface of the valve body, whereby the valve body and each outlet port are airtightly sealed.

As described above, since the valve body is sandwiched between the pair of seat members and the pair of seat members is pressed by the elastic force of the O-ring, a rotational force (torque) is required to rotate the valve body.

Incidentally, the flow path switching valve needs to be designed so as to secure a leakage amount of the specification. In order to ensure the leakage amount of the specification, the maximum compression ratio is calculated from the minimum compression ratio of the O-ring in consideration of dimensional tolerance of each part, influence of temperature, aging deterioration, and the like, and the torque for rotationally driving the valve body when the O-ring reaches the maximum compression ratio becomes the maximum torque.

For this reason, the specification of a rotation driving unit is determined such that a torque higher than the maximum torque is generated.

Furthermore, when the temperature rises, the O-ring expands to increase the compressibility, and the force for biasing the seat members, that is, the force for pressing the seat members against the ball valve increases, so that the frictional force between the seat members and the valve body increases. Therefore, it is also necessary to consider that the temperature rises and the frictional force increases, and it is also necessary to increase the torque for rotationally driving the valve body in consideration of the increase in the frictional force.

Therefore, in order to rotate the valve body by the rotation drive unit, it is necessary to consider the torque required when the temperature rises in addition to the maximum torque described above, and there is room for improvement in rotationally driving the valve body with a small torque.

In consideration of the above fact, an object of the disclosure is to provide a flow path switching valve in which a torque required for rotationally driving a valve body is hardly affected by a temperature.

### Solution to Problem

Conventionally, it is a matter of course that a member expands as a result of a temperature change, and as a method of coping with a case where a movement becomes hard as a result of the expansion of the member, a coping method such as taking a large gap between the members or increasing an operating force in a case in which a gap between the members cannot be secured has been common.

However, as a result of various experiments and studies on the flow path switching valve including the valve body having a ball shape, the inventor has found that when an angle θ of an inclined seal surface of the seat member with which an outer peripheral surface of the valve body is in contact is set to a certain value, a compression ratio of the elastic body at the minimum temperature in a use state and a compression ratio of the elastic body at the maximum temperature in the use state do not change.

The disclosure has been made in view of the above fact, and a flow path switching valve according to a first aspect includes: a valve main body in which a valve chamber is formed, an inlet/outlet port being opened in at least a pair of first wall surfaces facing each other of the valve chamber, and an interval dimension between one of the first wall surfaces and another of the first wall surfaces changing as a result of a temperature change: a valve body, having a ball shape, that is rotatably disposed in the valve chamber, that has a flow path formed in the valve body, and that has a diameter dimension that changes as a result of a temperature change: an annular seat member disposed between the valve body and the inlet/outlet port and disposed with a gap between an outer peripheral portion and a second wall surface of the valve chamber facing the outer peripheral portion to seal a connecting portion between the valve body and the inlet/outlet port, the annular seat member having a dimension in a radial direction and a dimension in a thickness direction orthogonal to the radial direction that changes as a result of a temperature change: an elastic body disposed in a compressed state between the seat member and the valve main body to press the seat member against the valve body, the elastic body having a dimension that changes as a result of temperature change: a rotary drive unit that rotates the valve body so that a communication state of a plurality of the inlet/outlet ports is selectively switched via the flow path of the valve body: and an inclined seal surface that is formed at an opening end of the seat member on a side of the valve body, that is inclined at a constant angle θ with respect to an axis when viewed in a cross section along the axis, and that is in contact with an outer peripheral surface of the valve body, in which a value of the angle θ is determined such that a compression ratio of the elastic body at a minimum temperature in a use state and a compression ratio of the elastic body at a maximum temperature in a use state do not change.

In this flow path switching valve, the valve body can be rotated using a rotational force (torque) of the rotary drive unit.

Then in this flow path switching valve, the value of the angle θ of the inclined seal surface with which the outer peripheral surface of the valve body is in contact is determined so that the compression ratio of the elastic body at the minimum temperature in the use state and the compression ratio of the elastic body at the maximum temperature in the use state do not change. As a result, the torque required for rotationally driving the valve body is hardly affected by the temperature.

In other words, it is possible to suppress an increase in the rotational force required to drive the valve body as the temperature rises. Therefore, it is not necessary to use a rotary drive unit having a large rotational force in consideration of an increase in rotational force, and a small rotary drive unit having a small rotational force can be used. Furthermore, the flow path switching valve can also be downsized.

### Advantageous Effects of Invention

As described above, according to the flow path switching valve of the disclosure, the torque required for rotationally driving the valve body is less likely to be affected by the temperature.

### BRIEF DESCRIPTION OF DRAWINGS

FIG. 1 is a perspective view illustrating a flow path switching valve according to an embodiment of the disclosure.

FIG. 2 is a cross-sectional view taken along line 2-2 of the flow path switching valve illustrated in FIG. 1.

FIG. 3 is a cross-sectional view of a valve body illustrating a flow path of the valve body.

FIG. 4 is an enlarged cross-sectional view illustrating a main part of the flow path switching valve.

FIGS. 5(A) and 5(B) are views for explaining a mechanism in which a compression ratio of an O-ring does not change depending on a temperature.

### DESCRIPTION OF EMBODIMENTS

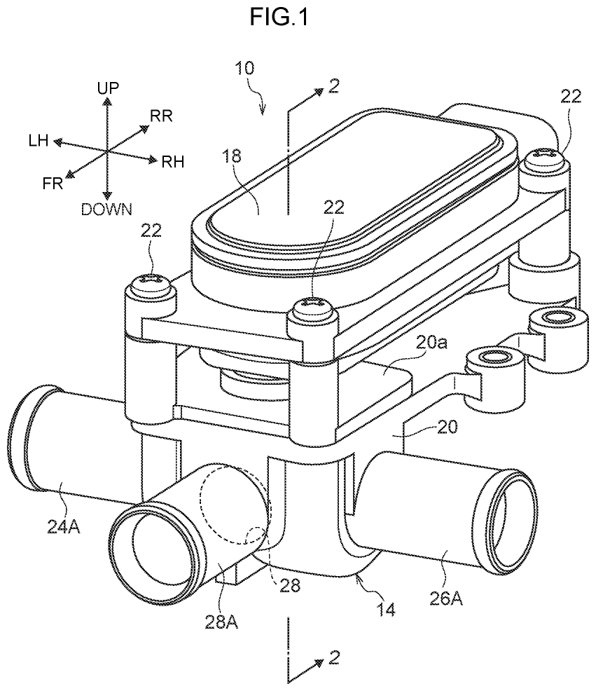

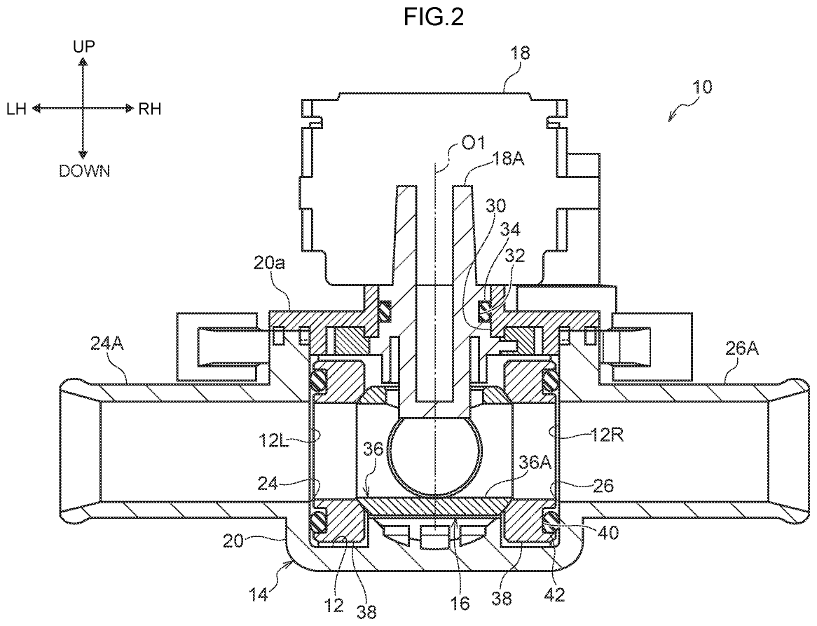

A flow path switching valve 10 according to an embodiment of the disclosure will be described with reference to FIGS. 1 to 5. Note that, in each of the drawings, a gap formed between members, a separation distance between members, and the like may be exaggerated in order to facilitate understanding of the invention and for convenience of drawing. Furthermore, in the present specification, descriptions indicating positions and directions such as up and down, left and right, front and back, and the like are based on the direction arrow display in FIGS. 1 and 2. Specifically, “UP” indicates an upward direction, “DOWN” indicates a downward direction, “LH” indicates a leftward direction, “RH” indicates a rightward direction, “FR” indicates a forward direction, and “RR” indicates a rearward direction. Note that these do not indicate a position and a direction in an actual use state.

### (Configuration of Flow Path Switching Valve)

FIG. 1 is a perspective view illustrating an overall configuration of the flow path switching valve 10 according to an embodiment of the disclosure, and FIG. 2 is a longitudinal sectional view (a sectional view taken along line 2-2) of the flow path switching valve 10 illustrated in FIG. 1.

The flow path switching valve 10 of the embodiment illustrated in FIG. 1 is used as, for example, a rotary three-way valve that switches a flow path of a fluid flowing in an engine compartment or the like of an automobile in multiple directions. Basically, as illustrated in FIG. 2, the flow path switching valve 10 includes a valve main body 14 having a valve chamber 12, a ball-shaped valve body (also referred to as a ball valve body) 16 rotatably disposed in the valve chamber 12, and a rotary drive unit 18 including a motor, a drive gear, and the like disposed from a rear portion to an upper portion of the valve main body 14 in order to rotate the valve body 16 around a rotation axis (in other words, a center line) O1.

Note that the rotation axis (axis extending in a vertical direction) O1 of the valve body 16 accommodated in the valve chamber 12 is coaxial with a center line of a valve shaft 18A of the rotary drive unit 18 described later.

### (Valve Main Body, Valve Chamber)

The valve main body 14 includes a base member 20 made of, for example, synthetic resin and a holder member 20a. As illustrated in FIG. 1, the holder member 20a is fixed to the base member 20 by a screw 22 together with the rotary drive unit 18.

As illustrated in FIG. 2, the base member 20 includes a sideways cylindrical valve chamber 12 formed therein. A lateral outflow port (in other words, an inlet/outlet port) 24 and a lateral outflow port (in other words, an inlet/outlet port) 26 opened to the valve chamber 12 are provided on a left first wall surface 12L on an arrow left direction side (left side in the drawing) and a right first wall surface 12R on an arrow right direction side (right side in the drawing) facing each other in the valve chamber 12. On an outer surface of the base member 20, ports 24A and 26A formed of pipe joints are integrally provided so as to communicate with the outflow ports 24 and 26.

Moreover, as illustrated in FIG. 1, the base member 20 is provided with a lateral inflow port (in other words, an inlet/outlet port) 28 opened to the valve chamber 12 on a wall surface of the valve chamber 12 on an arrow front direction side in the drawing. Note that on the outer surface of the base member 20, a port 28A formed of a pipe joint is integrally provided so as to communicate with the inflow port (inlet/outlet port) 28.

The holder member 20a is provided with a fitting insertion hole 30 through which the valve shaft 18A of the rotary drive unit 18 is rotatably inserted. A groove 32 is formed on an outer periphery of an axially intermediate portion of the valve shaft 18A, and an O-ring 34 as a seal member is fitted into the groove 32.

### (Rotary Drive Unit)

The valve shaft 18A of the rotary drive unit 18 is connected to the valve body 16, and the valve shaft 18A and the valve body 16 rotate integrally.

### (Valve Body)

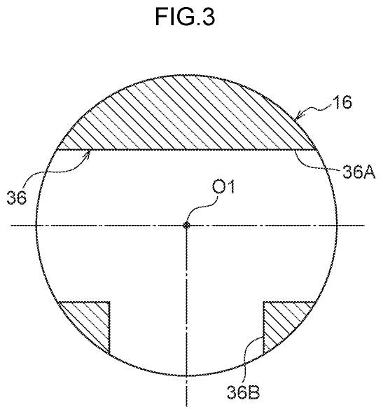

The valve body 16 is made of, for example, synthetic resin. As illustrated in FIGS. 2 and 3, a flow path (internal flow path) 36 is provided inside in order to selectively communicate the inflow port 28 and the two outflow ports 24 and 26 provided in the valve main body 14, in other words, to selectively switch a communication state between the inflow port 28 and the two outflow ports 24 and 26.

Specifically, as illustrated in FIG. 3, a through hole 36A penetrating in a first direction orthogonal to the direction of the rotation axis O1 of the valve body 16 is formed in the valve body 16, and a lateral hole 36B merging from an outer periphery (side portion) of the valve body 16 to a center of the through hole 36A is formed in a direction orthogonal to the rotation axis O1 of the valve body 16 and orthogonal to the through hole 36A.

### (Seat Member)

As illustrated in FIG. 2, an annular seat member 38 made of synthetic resin and having an opening corresponding to each of the outflow ports 24 and 26 is disposed around each of the outflow ports 24 and 26 on an inner wall surface (in other words, left and right wall surfaces of the valve chamber 12) of the valve main body 14.

That is, in the valve chamber 12 of the valve main body 14, a pair of the seat members 38 and 38 is disposed so as to be opposed to the rotation axis O1 of the valve body 16 corresponding to the pair of left and right outflow ports 24 and 26, and the valve body 16 is rotatably and slidably disposed between (inside) the pair of seat members 38 and 38.

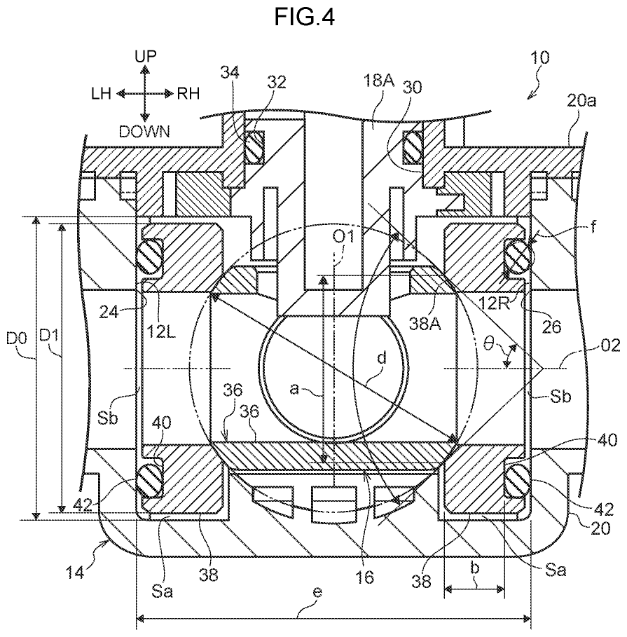

As illustrated in FIG. 4, an outer diameter DI of the seat member 38 is smaller than an inner diameter DO of the valve chamber 12. As a result, a gap Sa is provided between an outer peripheral surface of the seat member 38 and a wall surface (a second wall surface of the disclosure) of the valve chamber 12 facing the outer peripheral surface. The gap Sa does not disappear even when an outer diameter dimension of the seat member 38 and an inner diameter dimension of the valve chamber 12 change as a result of a temperature change.

An O-ring groove 40 is formed in the seat member 38 on a valve chamber wall surface side. An O-ring 42 as an example of an elastic body is disposed inside the O-ring groove 40 in a compressed state. The seat member 38 is biased toward the valve body 16 by the compressed O-ring 42. Note that the O-ring groove 40 is formed to be wider than the compressed O-ring 42.

In the seat member 38, an inclined seal surface 38A that is inclined at a constant angle θ° with respect to an axis O2 when viewed in a cross section along the axis O2 of the seat member 38 and in which an outer peripheral surface of the valve body 16 is in annular and linear contact is formed at an opening end on a side of the valve body 16. In other words, the inclined seal surface 38A is constituted by a part of a concave conical surface.

The inclined seal surface 38A of each seat member 38 is pressed by an elastic force (in other words, a repulsive force) of the O-ring 42 so as to be in close contact with the side of the valve body 16 (specifically, an outer peripheral seal surface side of the valve body 16), whereby a connecting portion between the valve body 16 and each of the outflow ports 24 and 26 is airtightly sealed.

Note that a gap Sb is provided between the seat member 38 and the left first wall surface 12L of the valve chamber 12 and between the seat member 38 and the right first wall surface 12R of the valve chamber 12 such that only the elastic force (that is, the force with which the compressed O-ring 42 tries to return to the original shape) of the O-ring 42 acts on the valve body 16 via the seat member 38.

Here, in the present embodiment, a diameter of the inclined seal surface 38A on an opening side is a (mm), a thickness dimension from a surface of the seat member 38 with which the O-ring 42 is in contact (a bottom surface of the O-ring groove 40) to a side surface of the seat member 38 on a valve body side is b (mm), a diameter of the valve body 16 is d (mm), an interval between the left first wall surface 12L and the right first wall surface 12R facing each other of the valve chamber 12 is e (mm), and a thickness (diameter) of the O-ring 42 before compression is f (mm).

Incidentally, the flow path switching valve 10 of the present embodiment can be used for a cooling circuit within an engine compartment or the like in a vehicle as an example. In a case in which the flow path switching valve 10 is used for switching a flow path of a coolant or the like, a temperature of the coolant changes depending on a use state.

In the flow path switching valve 10 of the present embodiment, a value of the angle θ of the inclined seal surface 38A is determined so that a compression ratio of the O-ring 42 at the minimum temperature in the use state and a compression ratio of the O-ring 42 at the maximum temperature in the use state do not change. By taking into account a linear expansion coefficient of each member and setting values of a, b, d, e, and f to optimum values, the value of the angle θ of the inclined seal surface 38A can be determined so that the compression ratio of the O-ring 42 at the minimum temperature in the use state and the compression ratio of the O-ring 42 at the maximum temperature in the use state do not change.

Note that, in the present embodiment, a material having a relatively larger linear expansion coefficient than the valve main body 14 and the valve body 16 is used for the seat member 38 and the O-ring 42.

As an example, polyphenylene sulfide (PPS) can be used for the valve main body 14 and the valve body 16, fluororesin (PTFE) can be used for the seat member 38, and synthetic rubber can be used for the O-ring 42.

### Action and Effect

Next, actions and effects of the flow path switching valve 10 of the present embodiment will be described.

In the flow path switching valve 10 of the present embodiment, when the valve body 16 is rotated in the valve chamber 12 by the rotary drive unit 18 including a motor, a drive gear, and the like, it is possible to selectively switch the communication state between the inflow port 28 and the two outflow ports 24 and 26 provided in the valve main body 14 through the flow path 36 provided in the valve body 16.

In the flow path switching valve 10 of the present embodiment, the value of the angle θ of the inclined seal surface 38A is determined so that the compression ratio of the O-ring 42 at the minimum temperature in the use state and the compression ratio of the O-ring 42 at the maximum temperature in the use state do not change, but a mechanism in which the compression ratio does not change will be described below:

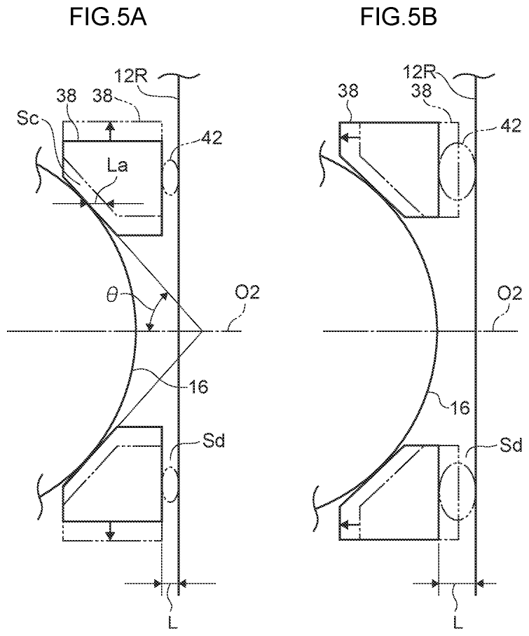

FIGS. 5(A) and 5(B) are schematic diagrams illustrating a periphery of the valve body for explaining a mechanism in which the compression ratio of the O-ring 42 does not change as a result of a temperature change (here, temperature rise), and shapes, dimensions, gaps, and the like of each part are exaggerated, and some configurations are omitted.

FIG. 5(A) schematically illustrates, as an example, the valve body 16, the seat member 38, the O-ring 42, and the right first wall surface 12R of the valve chamber 12 at a low temperature assumed at the time of use (Note that the O-ring groove is not illustrated.). The seat member 38 is biased toward the valve body 16 by the compressed O-ring 42, and the inclined seal surface 38A of the seat member 38 is in contact with the outer periphery of the valve body 16 as indicated by a solid line.

Note that here, it is assumed that the linear expansion coefficients of the materials constituting the seat member 38 and the O-ring 42 are relatively larger than the linear expansion coefficients of the materials constituting the valve body 16 and the valve main body 14.

When a temperature of the flow path switching valve 10 rises in a state illustrated in FIG. 5(A), the seat member 38 and the O-ring 42 expand, and a diameter of the seat member 38 increases as indicated by a two-dot chain line. As a result, the inclined seal surface 38A is separated from the valve main body 14, and a gap Sc is formed between the seat member 38 and the valve main body 14. Note that, although dimensions of the valve body 16 and the valve chamber 12 also change as a result of the temperature rise, since the change amount is relatively small with respect to the seat member 38 and the O-ring 42, a dimensional change of the valve body 16 and the valve chamber 12 is not illustrated in FIG. 5(A).

Since the seat member 38 is biased toward the valve body 16 by an elastic force of the O-ring 42, when a diameter of the seat member 38 increases, the seat member 38 moves toward the valve body 16 by a lateral dimension La of the gap Sc illustrated in FIG. 5(A). The seat member 38 and the valve body 16 have a positional relationship indicated by a solid line in FIG. 5(B), and a dimension L of a gap Sd between the seat member 38 and the right first wall surface 12R of the valve chamber 12 increases. Note that a two-dot chain line in FIG. 5(A) and a two-dot chain line in FIG. 5(B) indicate the seat member 38 in the same state.

If the O-ring 42 expands as a result of the temperature rise without changing the dimension L of the gap Sd between the seat member 38 and the right first wall surface 12R, the compression ratio of the O-ring 42 increases. However, as described above, since the diameter of the seat member 38 increases as a result of the temperature rise, and the dimension L of the gap Sd between the seat member 38 and the right first wall surface 12R of the valve chamber 12 increases, if it is possible to offset an amount by which the O-ring 42 increases and an amount by which the dimension L of the gap Sd between the seat member 38 and the right first wall surface 12R increases, the compression ratio of the O-ring 42 does not change. Note that the dimensions of the respective members constituting the flow path switching valve 10 change as a result of a temperature change, but the angle θ of the inclined seal surface 38A does not change as a result of a temperature change.

By using such a mechanism and determining the values of a, b, d, e, and f described above in consideration of the linear expansion coefficient of each component, the angle θ of the inclined seal surface 38A in which the compression ratio of the O-ring 42 does not change as a result of a temperature change can be obtained.

As a result, the seat member 38 is pressed against the valve body 16 with the same elastic force (biasing force) in both the case of the minimum temperature and the case of the maximum temperature in use, and the flow path switching valve 10 having a configuration in which the torque required for rotationally driving the valve body 16 is hardly affected by the temperature can be realized.

Note that in the flow path switching valve 10 of the present embodiment, the value of the angle θ of the inclined seal surface 38A is determined such that the compression ratio of the O-ring 42 at the minimum temperature in the use state and the compression ratio of the O-ring 42 at the maximum temperature in the use state do not change, that is,
the value of the angle θ is determined so as to be
compression ratio of O-ring 42 at minimum temperature (Cr1)
=compression ratio of O-ring 42 at maximum temperature in use state (Cr2). Here, in the disclosure, an error of 10% or less is included in comparison between the compression ratio at the minimum temperature and the compression ratio at the maximum temperature.

Note that in the present embodiment,
a=15.3 mm
b=4.7 mm
d=23 mm
e=30.9 mm
f=2.4 mm,
and when the angle θ=87°, the compression ratio of the O-ring 42 in an operating temperature range (from about −40° ° C. to 150° C.) is constant at 15%.

Among the above values, those having a large influence are d and a.

When the error range is 10%, the effect of the disclosure, that is, a fluctuation of the necessary torque within the operating temperature range can be suppressed by setting a range of d×a=from 315 to 385.

### OTHER EMBODIMENTS

Although one embodiment of the present disclosure has been described above, the present disclosure is not limited to the above, and it is needless to say that various modifications can be made in addition to the above without departing from the gist of the disclosure.

In the above embodiment, the O-ring 42 is attached to the O-ring groove 40 formed in the seat member 38, but the O-ring 42 may be attached to an O-ring groove formed in the left first wall surface 12L and the right first wall surface 12R.

It goes without saying that the number and arrangement configuration of the inlet/outlet port (inflow port and outflow port) formed in the valve main body 14 can be appropriately changed according to an application place and the like of the flow path switching valve 10. In the above embodiment, the three-way valve has been described as an example of the flow path switching valve 10, but it goes without saying that, for example, a two-way valve or four-way or more switching valve may be used.

Furthermore, although the flow path switching valve 10 of the above embodiment is used for flow path switching within an engine compartment or the like (an engine cooling circuit, an electronic device cooling circuit, or the like) in a vehicle, the application is not limited thereto, and it is needless to say that the flow path switching valve may be used for flow path switching in a hot water supply facility, for example.

The disclosure of Japanese Patent Application No. 2022-7451 filed on Jan. 20, 2022 is incorporated herein by reference in its entirety.

All documents, patent applications, and technical standards described in this specification are incorporated herein by reference to the same extent as if each individual document, patent application, and technical standard were specifically and individually indicated to be incorporated by reference.

1. A flow path switching valve, comprising:
a valve main body in which a valve chamber is formed, an inlet/outlet port being opened in at least a pair of first wall surfaces facing each other of the valve chamber, and an interval dimension between one of the first wall surfaces and another of the first wall surfaces changing as a result of a temperature change;
a valve body, having a ball shape, that is rotatably disposed in the valve chamber, that has a flow path formed in the valve body, and that has a diameter dimension that changes as a result of a temperature change;
an annular seat member disposed between the valve body and the inlet/outlet port and disposed with a gap between an outer peripheral portion and a second wall surface of the valve chamber facing the outer peripheral portion to seal a connecting portion between the valve body and the inlet/outlet port, the annular seat member having a dimension in a radial direction and a dimension in a thickness direction orthogonal to the radial direction that changes as a result of a temperature change;
an elastic body disposed in a compressed state between the seat member and the valve main body to press the seat member against the valve body, the elastic body having a dimension that changes as a result of a temperature change;
a rotary drive unit that rotates the valve body so that a communication state of a plurality of the inlet/outlet ports is selectively switched via the flow path of the valve body; and
an inclined seal surface that is formed at an opening end of the seat member on a side of the valve body, that is inclined at a constant angle θ with respect to an axis when viewed in a cross section along the axis, and that is in contact with an outer peripheral surface of the valve body,
wherein a value of the angle θ is set to 87 degrees such that a compression ratio of the elastic body at a minimum temperature in a use state and a compression ratio of the elastic body at a maximum temperature in a use state do not change.

2. The flow path switching valve according to claim 1, wherein
when a diameter on an opening side of the inclined seal surface is a and a diameter of the valve body is d,
d×a=from 315 to 385, and
a compression ratio of the elastic body is constant.
